(19) United States
(12) Patent Application Publication
(10) Pub. No.: US 2024/0264933 A1
(43) Pub. Date: Aug. 8, 2024

(54) READ PERFORMANCE IMPROVEMENT USING MEMORY DEVICE LATCHES

(71) Applicant: Micron Technology, Inc., Boise, ID (US)

(72) Inventors: Amiya Banerjee, Bangalore (IN); Sriraman Sridharan, Hosur (IN); Jameer Mulani, Bangalore (IN)

(21) Appl. No.: 18/424,464

(22) Filed: Jan. 26, 2024

Related U.S. Application Data
(60) Provisional application No. 63/482,924, filed on Feb. 2, 2023.

(51) Int. Cl. G06F 12/02

(52) U.S. Cl. CPC G06F 12/0246; G06F 2212/7201

(57) ABSTRACT

Methods, systems, and devices for read performance improvement using memory device latches are described. A memory system may determine whether a portion of an address mapping table is absent from a cache of one or more controllers and may read the portion of the address mapping table from memory cells of the memory device based on the portion of the address mapping table being absent from the cache. The memory system may communicate, to a memory device, a write command to store the portion of the address mapping table in a set of latches of the memory device based on the address mapping table being associated with an access command that is part of a non-sequential read procedure. The memory system may update a tracking table in the cache to indicate that the portion of the address mapping table is stored in the set of latches.

### CROSS REFERENCE

The present Application for Patent claims priority to and the benefit of U.S. Provisional Application No. 63/482,924 by Banerjee et al., entitled “READ PERFORMANCE IMPROVEMENT USING MEMORY DEVICE LATCHES,” filed Feb. 2, 2023, assigned to the assignee hereof, and is expressly incorporated by reference in its entirety herein.

### TECHNICAL FIELD

The following relates to one or more systems for memory, including read performance improvement using memory device latches.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports read performance improvement using memory device latches in accordance with examples as disclosed herein.

FIG. 2 illustrates an example of a system that supports read performance improvement using memory device latches in accordance with examples as disclosed herein.

FIG. 3 illustrates an example of a process flow that supports read performance improvement using memory device latches in accordance with examples as disclosed herein.

FIG. 4 illustrates an example of a process flow that supports read performance improvement using memory device latches in accordance with examples as disclosed herein.

FIG. 5 illustrates a block diagram of a memory system that supports read performance improvement using memory device latches in accordance with examples as disclosed herein.

FIGS. 6 and 7 illustrate flowcharts showing methods that support read performance improvement using memory device latches in accordance with examples as disclosed herein.

### DETAILED DESCRIPTION

A memory system may include one or more controllers that manage one or more memory devices included in the memory system. To facilitate management, the one or more controllers may include a cache memory (e.g., a local volatile memory, such as SRAM) that the controller uses to load address mapping information from an address mapping table (e.g., a logical-to-physical (L2P) table) that is stored in the memory cells of the memory devices. The address mapping information may allow the memory system to map logical addresses used by a host system to physical addresses of the memory devices so that the one or more controllers can perform address translation. If the cache memory is not large enough to accommodate the entire address mapping table (e.g., due to size constraints, cost constraints), the one or more controllers may load portions of the address mapping table associated with active regions of logical addresses into the cache memory from the memory cells of the memory devices. But retrieving portions of the address mapping table from the memory cells of the memory devices may be a time consuming process that undesirably increases the latency of the memory system.

According to the techniques described there, the latency of a memory system may be reduced, among other advantages, by storing portions of the address mapping table in latches of the memory devices, which may have faster access times than the memory cells of the memory devices. For example, after loading a portion of the address mapping table from the memory cells of a memory device into the cache memory, the one or more controllers of the memory system may store the portion of the address mapping table back into one or more latches that are internal to a memory device (the same memory device or another memory device). In this way, the one or more controllers may reduce latency during a later retrieval procedure for the portion of the address table by reading the portion from the one or more latches (as opposed to reading the portion from memory cells).

In addition to applicability in memory systems as described herein, techniques for improved read performance using memory device latches may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by facilitating better read operation performance using memory device latches, which may reduce latency, improve response times, or otherwise improve user experience, among other benefits.

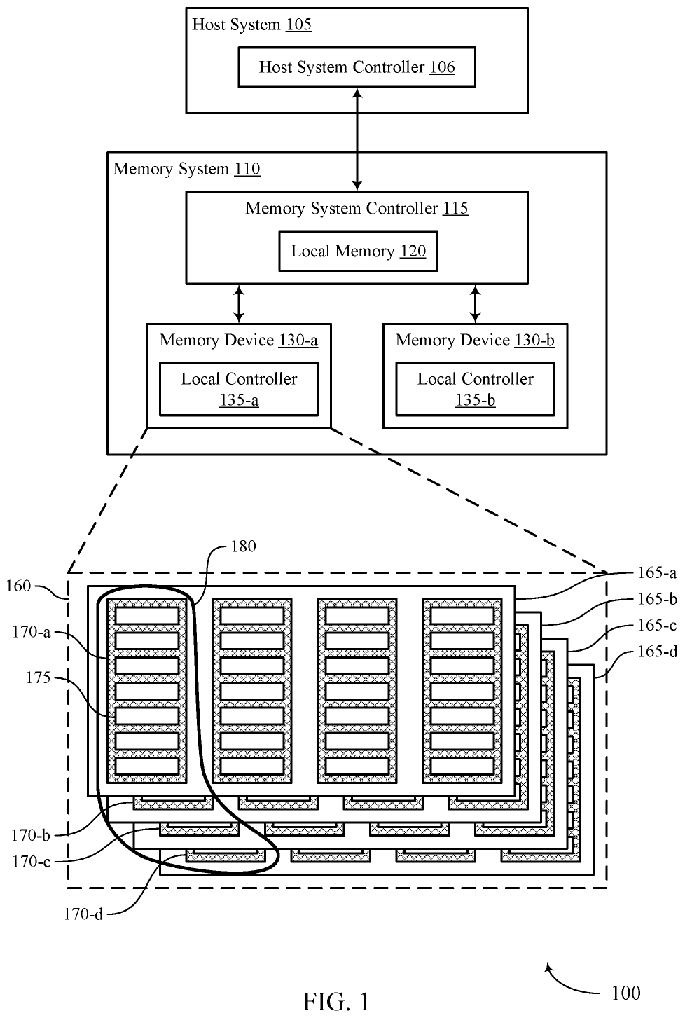

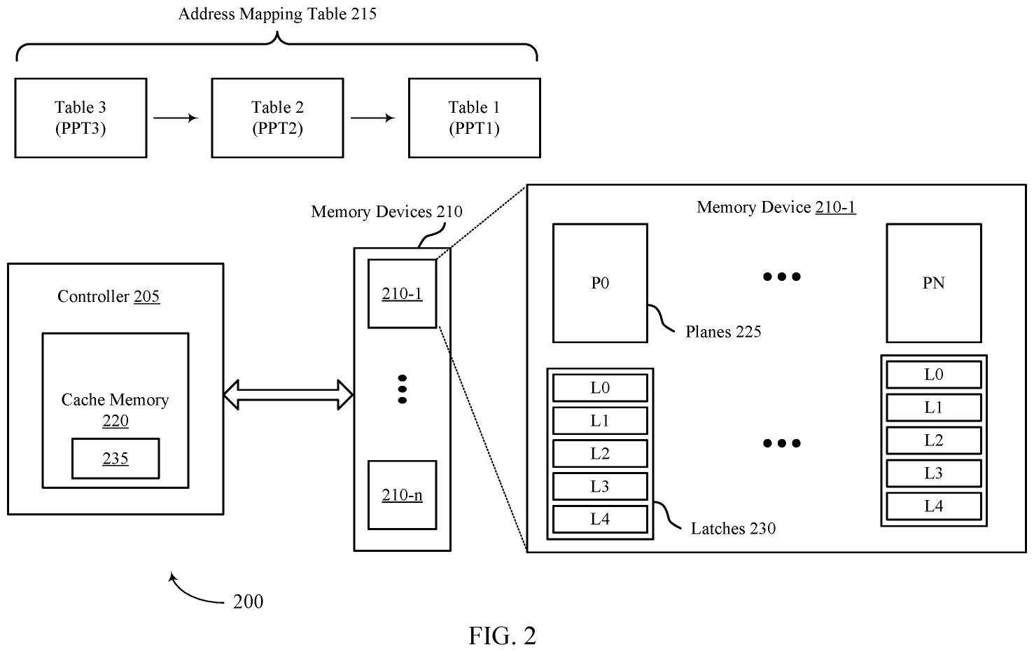

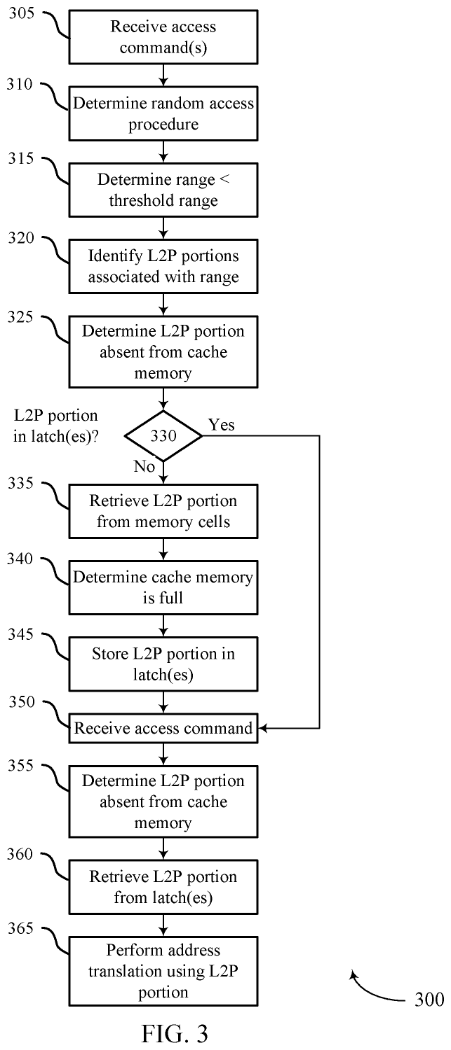

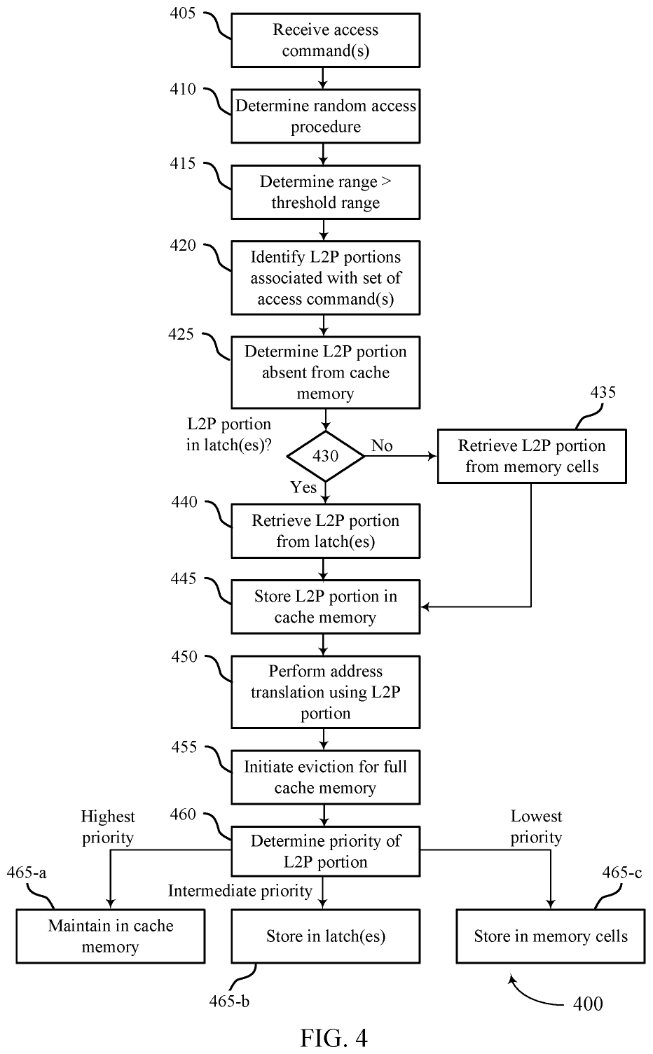

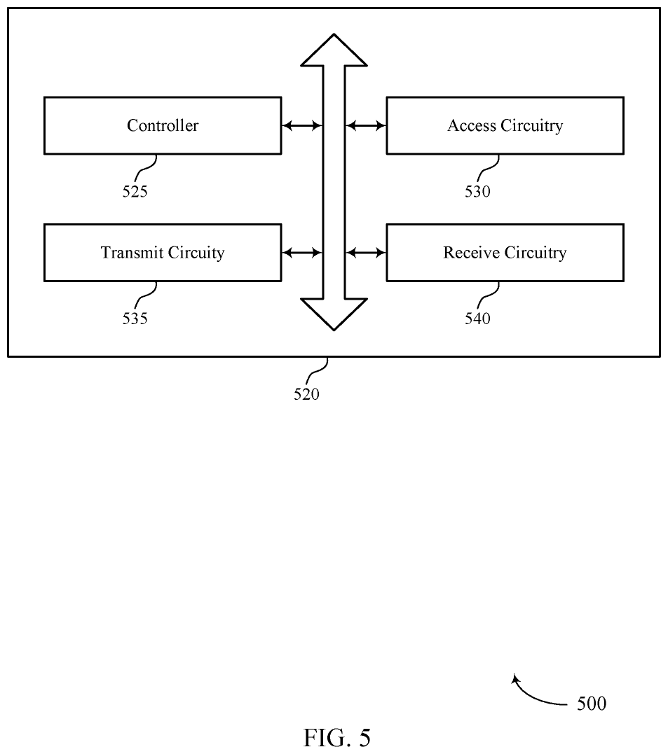

Features of the disclosure are initially described in the context of systems, devices, and circuits with reference to FIGS. 1 through 2. Features of the disclosure are described in the context of process flows with reference to FIGS. 3 through 4. These and other features of the disclosure are further illustrated by and described in the context of an apparatus diagram and flowcharts that relate to read performance improvement using memory device latches with reference to FIGS. 5 through 7.

FIG. 1 illustrates an example of a system 100 that supports read performance improvement using memory device latches in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with one or more host system controllers 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include one or more memory system controllers 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including one or more memory system controllers 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, one or more memory system controllers 115 or one or more local controllers 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

To service access commands from the host system 105, the memory system controller 115 may load address mapping information associated with the access commands into the local memory 120 for address translation. For example, the memory system controller 115 may read a portion of an address mapping table (e.g., an L2P table) that is stored in memory cells of the memory device(s) 130 and write that portion of the address mapping table into the local memory 120. The memory system controller 115 may retrieve address mapping information from the memory cells for regions of active logical addresses because the size (e.g., storage capacity) of the local memory 120 is insufficient to store the entire address mapping table. For instance, the area of the local memory 120 that is reserved for (e.g., dedicated to) address mapping information may be smaller than the size of the address mapping table.

But retrieving address mapping information from the memory cells of the memory device(s) 130 may be a time consuming process that increases the latency of the memory system 110 (e.g., by slowing down address translation). According to the techniques described herein, the memory system 110 may reduce latency by storing at least some address mapping information in latches of the memory device(s) 130, which may have lower-latency access times than the memory cells of the memory device(s) 130. For example, upon determining to evict a portion of the address mapping table from the local memory 120 (e.g., to make space for new address mapping information), the memory system controller 115 may write the portion of the address mapping table to one or more latches of the memory device(s) 130. The memory system controller 115 may maintain a tracking table that indicates which portions of the address mapping table are stored in latches (and which latches the different portions are stored in).

In some examples, the memory system controller 115 may determine whether to write address mapping information to latches or to memory cells based on (e.g., as a function of) the type of access procedure associated with the address mapping information. For instance, the memory system controller 115 may write address mapping information to latches if the address mapping information is associated with access commands that are part of a random read procedure (also referred to as a non-sequential read procedure) that targets non-sequentially indexed logical addresses. However, the memory system controller 115 may write address mapping information to memory cells if the address mapping information is associated with access commands that are part of a sequential read procedure that targets sequentially indexed logical addresses. Unlike in a sequential read procedure, the memory system controller 115 may not know which portions of the address mapping table are involved in a random read procedure, so storing the address mapping information involved in a random read procedure in latches (instead of memory cells) may help reduce the latency of address translation for the random read procedure. Put another way, random read procedures maybe associated with higher miss rates relative to sequential read procedures, so storing the address mapping information involved in a random read procedure in latches may have a more significant impact (e.g., reduction) on latency compared to sequential read procedures.

The system 100 may include any quantity of non-transitory computer readable media that support read performance improvement using memory device latches. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

FIG. 2 illustrates an example of a memory system 200 that supports read performance improvement using memory device latches in accordance with examples as disclosed herein. The memory system 200 may be an example of a memory system 110 as described with reference to FIG. 1 or aspects thereof. The memory system 200 may include a controller 205, which may be an example of the memory system controller 115, and memory devices 210, which may be examples of the memory devices 130. The memory system 200 may reduce operational latency by storing at least some of the address mapping information of the address mapping table 215 in latches of the memory devices 210.

The memory system 200 may be configured to store data received from a host system and to send data to the host system, if requested by the host system using access commands (e.g., read commands or write commands). Accordingly, the memory system 200 may include memory devices 210 (e.g., memory device 210-1 through memory device 210-n) to store data transferred between the memory system 200 and the host system, e.g., in response to receiving access commands from the host system.

A memory device 210 may include N planes 225 (denoted plane 0 through plan N), each of which may have associated latches 230 (denoted L0 through L4). The latches 230 may facilitate access operations (e.g., read operations, write operations) by storing data involved in the access operations. In some examples, one of the latches 230 for a plane (e.g., latch L4, which may also be referred to as the SDC latch), may serve as a gateway latch between the controller 205 and the other latches for that plane (e.g., data transferred between the latches 230 and the controller 205 may be routed through the latch L4). Each of the latches 230 may include multiple latch circuits, each capable of storing a single bit, such that each of the latches 230 (e.g., L0 through L4) may store a quantity of bits corresponding to a page for the corresponding plane. The latch circuits may be implemented in the memory device as either level-triggered (e.g., transparent latches) or edge-triggered (e.g., flip-flops). Although described as having five latches 230 (e.g., L0 through L4), some memory devices may have fewer or more latches 230. In some cases, each memory device 210 may include M+1 latches 230, where M may represent a quantity of bits stored in a memory cell at a highest supported density (e.g., highest quantity of bits stored in each of the multiple-level memory cells).

The controller 205 may execute commands (e.g., access commands) received from the host system and control the movement of information (e.g., data, address mapping information) within the memory system 200. For instance, the controller 205 may manage the transfer of information to and from the memory devices 210, e.g., for storing information, retrieving information, and determining memory locations in which to store information and from which to retrieve information. The controller 205 may perform address translation (e.g., conversion of logical addresses to physical addresses) based on (e.g., using) address mapping information in the cache memory 220. The controller 205 may manage the in-flow and out-flow of address mapping information as described herein, including the retrieval and storage of portions of the address mapping table 215.

The cache memory 220 may store information (e.g., data) for transfer to the non-volatile memory or for transfer to the host system. The cache memory 220 may also store (e.g., in an area reserved for address mapping information) address mapping information for address translation by the controller 205. The cache memory 220 may be a volatile-type of memory, such as DRAM or SRAM, and may be an example of the local memory 120 described with reference to FIG. 1.

The address mapping table 215 may include address mapping information that allows the memory system 200 to map logical address used by the host system (and associated with access commands) to physical addresses that identify physical memory locations of the memory devices 210. In some examples, the address mapping table 215 may include multiple tables, such as table 3 (which may also be referred to a physical page table 3 (PPT3)), table 2 (which may also be referred to as PPT2), and table 1 (which may also be referred to as PPT1) that allow the controller 205 to locate specific address mapping information.

Table 1 may include the address mapping information for memory system 200 (e.g., one-to-one logical address to physical address mappings), table 2 may include information that maps ranges of logical addresses to portions of table 1, and table 3 may include information that maps ranges of logical addresses to portions of table 2. For instance, table 3 may include x entries, each of which is mapped to a respective y (e.g., 1024) entries in table 2, and each entry of table 2 maybe mapped to a respective z (e.g., 1024) entries in table 1. As an example, to determine the address mapping information for a logical address, the controller 205 may first reference table 3 to find the corresponding entry that points to a set of entries in table 2, then find the corresponding entry in the set of entries in table 2 that points to a set of entries in table 1, then find the corresponding L2P entry in the set of entries in table 1.

To facilitate access operations, the controller 205 may transfer address mapping information of the address mapping table 215 into the cache memory 220. Initially, the address mapping table 215 may be stored in memory cells of the memory devices 210. To perform address translation for an access command, the controller 205 may retrieve the address mapping information associated with the access command from the memory cells that store the address mapping information (e.g., the controller 205 may send read command(s) that target the memory cells). For instance, the controller 205 may retrieve table 3 of the address mapping table 215 from the memory cells that store table 3. The controller 205 may also retrieve 1) a corresponding portion of table 2 (based on table 3) from memory cells that store table 2, and 2) a corresponding portion of table 3 (based on table 2) from memory cells that store table 3.

After retrieving a portion of the address mapping table 215, the memory system 200 may store the portion to the cache memory 220 (e.g., for direct use) or may by-pass the cache memory 220 and store the portion to the latches 230 (e.g., for future use). If the portion is stored in the cache memory 220, the memory system 200 may use the portion to perform address translation, then store the portion in the latches 230 upon evicting the portion from the cache memory 220. If cache memory 220 is by-passed, the memory system 200 may wait until a corresponding access command is received to copy the portion from the latches 230 to the cache memory 220. In either case, the memory system 200 may store the portion in the latches 230 based on (e.g., due to) the portion being associated with one or more access commands that are part of a random read procedure.

To store a portion of the address mapping table in the cache memory 220, the controller 205 may issue write commands that indicate (e.g., identify) the latches 230 to which the portion is to be written. If the indicated latches 230 are empty (e.g., available to store the portion), the memory device 210 may store the portion in the indicated latches and send confirmation to the controller 205. If the indicated latches 230 are full (e.g., unavailable to store the portion), the memory device 210 may store the portion in substitute latches and indicate the substitute latches to the controller 205. Thus, the controller 205 may receive an indication of the latches to which the portion is ultimately stored. The memory system 200 may maintain a tracking table 235 (e.g., in the cache memory 220) that indicates the latches 230 that store the portions.

To read a portion of the address mapping table 215 from the cache memory 220, the controller 205 may issue one or more read command(s) that indicate (e.g., identify) the latches 230 from which the portion is to be read. The controller 205 may reference the tracking table to determine the latches to target with the read command(s).

After writing a portion of the address mapping table 215 in the cache memory 220, the memory system may refrain from writing the portion back to the memory cells of the memory device 210 (which may still have the portion stored). In some examples, the format of a portion of the address mapping table 215 may be different depending on the location of storage. For example, a portion of the address mapping table 215 may have a first format (e.g., include parity bits) if stored in the memory cells of the memory device 210 and may have a second format (e.g., omit all or a portion of the parity bits) if stored in the latches 230. Thus, in some cases the second format may include fewer parity bits than the first format for a portion of the address mapping table 215.

In some examples, the controller 205 may retrieve a portion of the address mapping table 215 in advance of receiving a corresponding access command (e.g., an access command that indicates a logical address associated with that portion). That is, the controller 205 may prefetch a portion of the address mapping table 215 in anticipation of receiving a corresponding access command. The controller 205 may prefetch a portion of the address mapping table if the controller 205 determines that a range of logical address associated with a set of commands for a random read procedure is less than a threshold range. In a prefetching scenario, the controller 205 may preferentially store prefetched portions in the cache memory 220 until the controller 205 determines that the cache memory 220 is full (e.g., at capacity), at which point the controller 205 may shift to storing prefetched portions in the latches 230 (e.g., by-passing the cache memory 220).

In some examples, the controller 205 may retrieve a portion of the address mapping table 215 based on (e.g., in response to) receipt of a corresponding access command (e.g., an access command that indicates a logical address associated with that portion). That is, the controller 205 may post-fetch a portion of the address mapping table 215 after receiving a corresponding access command. The controller 205 may decide to post-fetch portions of the address mapping table 215 if the controller 205 determines that a range of logical address associated with a set of commands for a random read procedure is greater than a threshold range. In a post-fetching scenario, the controller 205 may store retrieved portions of the address mapping table 215 in the cache memory 220 and use the portions to perform address translation. Upon determining to evict (e.g., erase, overwrite) the portions from the cache memory 220, the controller 205 may write one or more of the portions to the latches 230.

In either scenario (prefetching or post-fetching), the controller 205 may determine whether to store a portion of the address mapping table 215 in the latches 230 based on (e.g., according to) the priority level of the portion. For example, the controller 205 may determine to store high priority portions in the cache memory 220, store intermediate priority portions in the latches 230, and low priority portions in the memory cells (e.g., planes 225) of the memory device 210. The priority level of a portion may be determined based on (e.g., as a function of) the frequency of use for that portion (e.g., the quantity of times the portion has been used for address translation in a threshold amount of time), where portions with high frequencies of use are assigned the high priority level, portions with moderate frequencies of use are assigned the intermediate priority level, and portions with low frequencies of use are assigned the low priority level.

Thus, the memory system 200 may reduce operational latency by storing at least some portions of the address mapping table 215 in latches of the memory devices 210.

FIG. 3 illustrates an example of a process flow 300 that supports read performance improvement using memory device latches in accordance with examples as disclosed herein. The process flow 300 may be implemented by a memory system such as the memory system 110 or the memory system 200 as described with reference to FIGS. 1 and 2, respectively. The process flow 300 may illustrate operations of the memory system in a prefetching scenario in which the memory system A) retrieves portions of an address mapping table in anticipation of receiving corresponding access commands and B) stores the portions in latches of one or more memory devices while waiting for the corresponding access commands. Portions of the address mapping table may be referred to as L2P portions.

Aspects of the process flow 300 may be implemented by one or more controllers, among other components. Additionally or alternatively, aspects of the process flow 300 may be implemented as instructions stored in memory (e.g., firmware stored in a memory coupled with a memory system). For example, the instructions, if executed by one or more controllers (e.g., the controller 205), may cause the one or more controllers to perform the operations of the process flow 300.

At 305, a set of one or more access commands may be received (e.g., by the memory system 200) from a host system. At 310, it may be determined that the set of access commands are for a non-sequential read procedure (e.g., a random read procedure) in which non-sequentially indexed logical addresses are targeted. The memory system may determine to store portions of the address mapping table in latches based on (e.g., due to) the access commands being for the non-sequential read procedure. In some cases, the memory system may determine the location for storing portions of the address mapping table based on the type of read procedure (e.g., sequential versus non-sequential) being performed.

In some examples, the memory system may also determine a range of logical addressed associated with the non-sequential read procedure. The range of logical addresses may be determined based on (e.g., from) an indication of the range from the host system or based on the highest and lowest indexed logical addresses associated with the set of access commands, among other options. If the range of logical addresses is determined based on the highest and lowest indexed logical addresses associated with the set of access commands, the memory system may extend the range by a threshold amount relative to the highest and lowest indexed logical addresses. In some examples (e.g., if table 3 is not already stored in the cache memory 220), the memory system may load the table 3 (PPT3) into the cache memory 220 so that the memory system can determine which portions of the address mapping table 215 (e.g., which portions of table 2 and table 1) to retrieve.

At 315, it may be determined that the range of logical addresses associated with the non-sequential read procedure satisfies (e.g., is less than or equal to) a threshold range. The memory system may determine to prefetch portions of the address mapping table based on (e.g., due to) the range being less than the threshold range.

At 320, portions of the address mapping table that are associated with the range (but not necessarily corresponding to the set of access commands) may be identified. At 325, it may be determined that one of the portions associated with the range is absent from the cache memory 220. At 330, based on (e.g., in response to) determining that the portion is absent from the cache memory 220, it may be determined whether the portion is already stored in latches of the memory device(s). The memory system may determine whether the portion is already stored in latches by referencing a tracking table that maps portions of the address mapping table to latches of the memory device.

If, at 330, it is determined that the portion is already stored in latches of the memory device(s), the memory system may proceed to 350. If, at 330, it is determined that the portion is not already stored in latches of the memory device(s), the memory system may proceed to 335 and retrieve the portion from the memory cells of a memory device.

At 340, it may be determined that the cache memory 220 is full. At 345, the portion may be stored in one or more latches of a memory device (e.g., the same memory device from which the portion was retrieved or a different memory device). For example, the controller 205 may communicate to the memory device a write command that indicates the latch(es) in which the portion is to be written. Because the latch(es) are the target destination for the portion, the controller 205 may refrain from sending a subsequent write command for writing the portion to memory cells of the memory device. In some examples, the memory system may store the portion in the latch(es) based on (e.g., in response to) determining that the cache memory 220 is full.

In some examples, the portion stored in the latch(es) may have a different format than the corresponding portion that is maintained in the memory cells (e.g., the portion stored in the latch(es) may have fewer parity bits than the corresponding portion that is maintained in the memory cells). In some examples, the format of the portion stored in the latch(es) may be the same format used for the portion in the cache memory 220.

At 350, an access command (e.g., a read command) corresponding to the portion may be received. Thus, in the prefetch scenario, an access command that indicates a logical address associated with the portion of the address mapping table may be received after the portion has already been retrieved and stored in the latch(es). At 355, it may be determined that the portion corresponding to the access command is absent from the cache memory 220. Accordingly, at 360, the portion may be retrieved from the latch(es) and loaded into the cache memory 220. The memory system may retrieve the portion from the latch(es) by communicating a read command that indicates (e.g., identifies) the latch(es) that store the portion. The read command may be associated with reading the portion from the latch(es) without reading the portion from the memory cells (e.g., the read command may transfer the portion from the latch(es) to the controller without accessing the memory cells associated with the portion). Thus, the memory system may refrain from reading the portion from memory cells, and instead read the portion from the latch(es), which be associated with a lower latency than reading the portion from the memory cells.

At 365, address translation (for the logical address associated with the access command) may be performed using the portion so that the memory system can perform an access operation associated with the access command.

Thus, a memory system may reduce latency by prefetching portions of an address mapping table and storing the portions in latches of one or more memory devices. Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

FIG. 4 illustrates an example of a process flow 400 that supports read performance improvement using memory device latches in accordance with examples as disclosed herein. The process flow 400 may be implemented by a memory system such as the memory system 110 or the memory system 200 as described with reference to FIGS. 1 and 2, respectively. The process flow 400 may illustrate operations of the memory system in a post-fetching scenario in which the memory system A) retrieves portions of an address mapping table in response to receiving corresponding access commands and B) stores the portions in latches of one or more memory devices after performing address translation for the corresponding access commands.

Aspects of the process flow 400 may be implemented by one or more controllers, among other components. Additionally or alternatively, aspects of the process flow 400 may be implemented as instructions stored in memory (e.g., firmware stored in a memory coupled with a memory system). For example, the instructions, if executed by one or more controllers (e.g., the controller 205), may cause the one or more controllers to perform the operations of the process flow 400.

At 405, a set of one or more access commands may be received (e.g., by the memory system 200) from a host system. At 410, it may be determined that the set of access commands are for a non-sequential read procedure (e.g., a random read procedure) in which non-sequentially indexed logical addresses are targeted. The memory system may determine to store portions of the address mapping table in latches based on (e.g., due to) the access commands being for the non-sequential read procedure.

In some examples, the memory system may also determine a range of logical addressed associated with the non-sequential read procedure. The range of logical addresses may be determined based on (e.g., from) an indication of the range from the host system or based on the highest and lowest indexed logical addresses associated with the set of access commands, among other options. In some examples (e.g., if table 3 is not already stored in the cache memory 220), the memory system may load the table 3 (PPT3) into the cache memory 220 so that the memory system can determine which portions of the address mapping table 215 (e.g., which portions of table 2 and table 1) to retrieve.

At 415, it may be determined that the range of logical addresses associated with the non-sequential read procedure satisfies (e.g., is greater than or equal to) a threshold range. The memory system may determine not to prefetch portions of the address mapping table based on the range being greater than the threshold range.

At 420, portions of the address mapping table corresponding to the set of access commands may be identified. At 425, it may be determined that one of the portions associated with the range is absent from the cache memory 220. At 430, based on (e.g., in response to) determining that the portion is absent from the cache memory 220, it may be determined whether the portion is already stored in latches of the memory device(s). The memory system may determine whether the portion is already stored in latches by referencing a tracking table that maps portions of the address mapping table to latches of the memory device.

If, at 430, it is determined that the portion is not already stored in latches of the memory device(s), the memory system may proceed to 435 and retrieve the portion from the memory cells of a memory device. If, at 430, it is determined that the portion is already stored in latches of the memory device(s), the memory system may proceed to 440 and retrieve the portion from the latch(es). The memory system may retrieve the portion from the latch(es) by communicating a read command that indicates the latch(es) from which the portion is to be read. The read command may be associated with reading the portion from the latch(es) without reading the portion from the memory cells (e.g., the read command may transfer the portion from the latch(es) to the controller without accessing the memory cells associated with the portion).

At 445, the portion may be stored in the cache memory for address translation. At 450, the portion may be used to perform address translation for the access command(s) corresponding to the portion (e.g., the access commands that indicate logical addresses covered by the portion). After performing address translation, the memory system may perform the access operation(s) associated with the access commands.

At 455, an eviction procedure may be initiated in which one or more portions in the cache memory is stored elsewhere (e.g., written to latches or another memory media) before being discarded or overwritten in the cache memory. The memory system may initiate the eviction procedure based on (e.g., in response to) determining that the cache memory is full (e.g., has a threshold percentage of cells written). As part of the eviction procedure, the memory system may evaluate portions in the cache memory to determine the proper destination location for the portions (e.g., the memory system may determine whether a portion in the cache memory should be maintained in the cache memory, written to latches, or written to memory cells of the memory device).

At 460, the priority level of the portion stored in the cache memory at 445 (or a different portion) may be determined. The memory system may determine the priority level of the portion based on (e.g., as a function of) the frequency of use for that portion (e.g., the quantity of times the portion has been used for address translation in a threshold amount of time). If the portion has the highest priority level, the portion may be maintained in the cache memory at 465-a (e.g., the memory system may refrain from discarding or overwriting the portion). If the portion has the intermediate priority level, the portion may be stored in (e.g., written to) one or more latch(es) of a memory device at 465-b. If the portion has the lowest priority level, the portion may at 465-c, be stored in (e.g., written to) the memory cells of a memory device (e.g., if the portion has been updated since retrieval) or discarded or over-written (e.g., if the portion has not been updated since retrieval, meaning that the original version of the portion is still in the memory cells).

Thus, a memory system may reduce latency by post-fetching portions of an address mapping table and storing the portions in latches of one or more memory devices. Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

FIG. 5 illustrates a block diagram 500 of a memory system 520 that supports read performance improvement using memory device latches in accordance with examples as disclosed herein. The memory system 520 may be an example of aspects of a memory system as described with reference to FIGS. 1 through 4. The memory system 520, or various components thereof, may be an example of means for performing various aspects of read performance improvement using memory device latches as described herein. For example, the memory system 520 may include one or more controllers 525, an access circuitry 530, a transmit circuity 535, a receive circuitry 540, or any combination thereof. Each of these components may communicate, directly or indirectly, with one another (e.g., via one or more buses).

The one or more controllers 525 may be configured as or otherwise support a means for determining whether a portion of an address mapping table is absent from a cache of a controller, where the address mapping table includes information for mapping logical addresses to physical addresses. The access circuitry 530 may be configured as or otherwise support a means for reading the portion of the address mapping table from memory cells of a memory device based at least in part on the portion of the address mapping table being absent from the cache. The transmit circuity 535 may be configured as or otherwise support a means for communicating, to the memory device, a write command that indicates the portion of the address mapping table is to be stored in a set of latches of the memory device based at least in part on the address mapping table being associated with an access command that is part of a non-sequential read procedure and on reading the portion of the address mapping table. In some examples, the one or more controllers 525 may be configured as or otherwise support a means for updating a tracking table in the cache to indicate that the portion of the address mapping table is stored in the set of latches.

In some examples, the non-sequential read procedure targets non-sequentially indexed logical addresses. In some examples, the one or more controllers 525 may be configured as or otherwise support a means for refraining, after storing the portion of the address mapping table in the set of latches, from writing the portion of the address mapping table to the memory device based at least in part on determining that the portion of the address mapping table has not been changed.

In some examples, the one or more controllers 525 may be configured as or otherwise support a means for determining that an area of the cache reserved for address mapping information is full, where the portion of the address mapping table is stored in the set of latches based at least in part on the area being full.

In some examples, the one or more controllers 525 may be configured as or otherwise support a means for determining whether a range of logical addresses associated with a set of received access commands is less than a threshold range, where the portion of the address mapping table is read before receipt of the access command associated with the portion based at least in part on the range being less than the threshold range.

In some examples, the receive circuitry 540 may be configured as or otherwise support a means for receiving the access command associated with the portion of the address mapping table, where the portion of the address mapping table is read based at least in part on receipt of the access command.

In some examples, the one or more controllers 525 may be configured as or otherwise support a means for storing the portion of the address mapping table in the cache based at least in part on reading the portion of the address mapping table. In some examples, the one or more controllers 525 may be configured as or otherwise support a means for determining to evict the portion of the address mapping table from the cache, where the portion of the address mapping table is stored in the set of latches based at least in part on determining to evict the portion of the address mapping table.

In some examples, the one or more controllers 525 may be configured as or otherwise support a means for determining that the portion of the address mapping table has an intermediate priority level, where the portion of the address mapping table is stored in the set of latches based at least in part on the portion of the address mapping table having the intermediate priority level.

In some examples, the one or more controllers 525 may be configured as or otherwise support a means for determining that a second access command associated with the portion of the address mapping table has been received. In some examples, the one or more controllers 525 may be configured as or otherwise support a means for copying the portion of the address mapping table from the set of latches to the cache based at least in part on the access command.

In some examples, the transmit circuity 535 may be configured as or otherwise support a means for communicating, to the memory device, a first access command to access additional memory cells of the memory device, where the access command maintains the portion of the address mapping table in the set of latches of the memory device. In some examples, the transmit circuity 535 may be configured as or otherwise support a means for communicating, to the memory device, a second access command to read the portion of the address mapping table from the set of latches based at least in part on executing an access command associated with the portion of the address mapping table.

In some examples, the one or more controllers 525 may be configured as or otherwise support a means for determining whether a portion of an address mapping table associated with an access command is absent from a cache of a controller, where the address mapping table including information for mapping logical addresses to physical addresses. In some examples, the one or more controllers 525 may be configured as or otherwise support a means for determining, based at least in part on the portion of the address mapping table being absent from the cache, that the portion of the address mapping table is stored in a set of latches of a memory device. The receive circuitry 540 may be configured as or otherwise support a means for receiving the portion of the address mapping table from the set of latches of the memory device based at least in part on determining that the portion of the address mapping table is stored in the set of latches. In some examples, the access circuitry 530 may be configured as or otherwise support a means for performing an access operation associated with the access command based at least in part on receiving the portion of the address mapping table.

In some examples, the one or more controllers 525 may be configured as or otherwise support a means for referencing a tracking table, in the cache, that indicates that the portion of the address mapping table is stored in set of latches, where the determination that the portion of the address mapping table is stored in the set of latches is based at least in part on referencing the tracking table.

In some examples, the transmit circuity 535 may be configured as or otherwise support a means for communicating, to the memory device, a read command for the portion that indicates the set of latches, where the portion of the address mapping table is received from the set of latches based at least in part on the read command.

In some examples, the one or more controllers 525 may be configured as or otherwise support a means for determining to evict a second portion of the address mapping table from the cache. In some examples, the one or more controllers 525 may be configured as or otherwise support a means for storing the second portion of the address mapping table in a second set of latches based at least in part on determining to evict the second portion.

In some examples, the one or more controllers 525 may be configured as or otherwise support a means for determining that the second portion of the address mapping table has an intermediate priority level, where the second portion of the address mapping table is stored in the second set of latches based at least in part on the second portion of the address mapping table having the intermediate priority level.

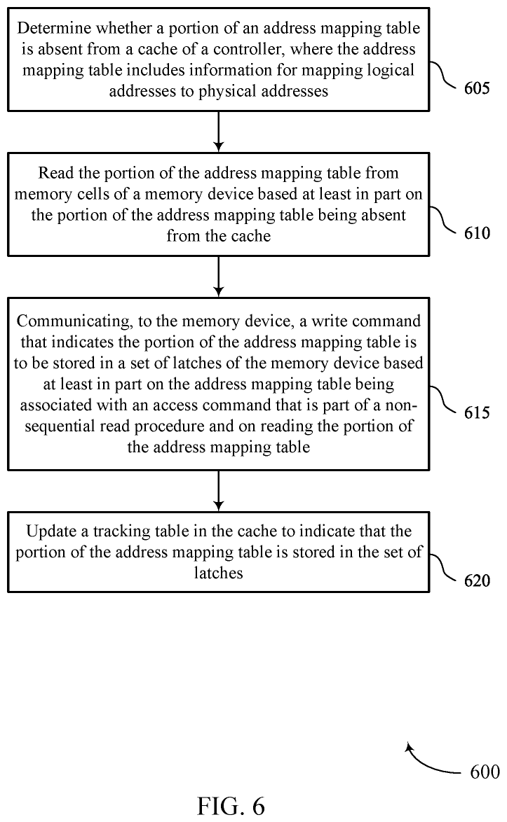

FIG. 6 illustrates a flowchart showing a method 600 that supports read performance improvement using memory device latches in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include determining whether a portion of an address mapping table is absent from a cache of a controller, where the address mapping table includes information for mapping logical addresses to physical addresses. The operations of 605 may be performed in accordance with examples as disclosed herein. In some examples, aspects of the operations of 605 may be performed by one or more controllers 525 as described with reference to FIG. 5.

At 610, the method may include reading the portion of the address mapping table from memory cells of a memory device based at least in part on the portion of the address mapping table being absent from the cache. The operations of 610 may be performed in accordance with examples as disclosed herein. In some examples, aspects of the operations of 610 may be performed by an access circuitry 530 as described with reference to FIG. 5.

At 615, the method may include communicating, to the memory device, a write command that indicates the portion of the address mapping table is to be stored in a set of latches of the memory device based at least in part on the address mapping table being associated with an access command that is part of a non-sequential read procedure and on reading the portion of the address mapping table. The operations of 615 may be performed in accordance with examples as disclosed herein. In some examples, aspects of the operations of 615 may be performed by a transmit circuity 535 as described with reference to FIG. 5.

At 620, the method may include updating a tracking table in the cache to indicate that the portion of the address mapping table is stored in the set of latches. The operations of 620 may be performed in accordance with examples as disclosed herein. In some examples, aspects of the operations of 620 may be performed by one or more controllers 525 as described with reference to FIG. 5.

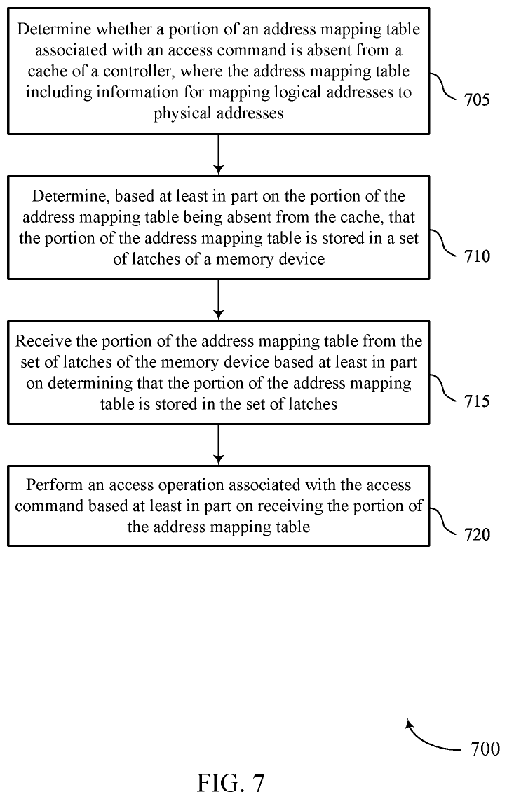

FIG. 7 illustrates a flowchart showing a method 700 that supports read performance improvement using memory device latches in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include determining whether a portion of an address mapping table associated with an access command is absent from a cache of a controller, where the address mapping table including information for mapping logical addresses to physical addresses. The operations of 705 may be performed in accordance with examples as disclosed herein. In some examples, aspects of the operations of 705 may be performed by one or more controllers 525 as described with reference to FIG. 5.

At 710, the method may include determining, based at least in part on the portion of the address mapping table being absent from the cache, that the portion of the address mapping table is stored in a set of latches of a memory device. The operations of 710 may be performed in accordance with examples as disclosed herein. In some examples, aspects of the operations of 710 may be performed by a controller 525 as described with reference to FIG. 5.

At 715, the method may include receiving the portion of the address mapping table from the set of latches of the memory device based at least in part on determining that the portion of the address mapping table is stored in the set of latches. The operations of 715 may be performed in accordance with examples as disclosed herein. In some examples, aspects of the operations of 715 may be performed by a receive circuitry 540 as described with reference to FIG. 5.

At 720, the method may include performing an access operation associated with the access command based at least in part on receiving the portion of the address mapping table. The operations of 720 may be performed in accordance with examples as disclosed herein. In some examples, aspects of the operations of 720 may be performed by an access circuitry 530 as described with reference to FIG. 5.

In some examples, an apparatus as described herein may perform a method or methods, such as the method 600 or the method 700. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for determining whether a portion of an address mapping table is absent from a cache of a controller, where the address mapping table includes information for mapping logical addresses to physical addresses; reading the portion of the address mapping table from memory cells of a memory device based at least in part on the portion of the address mapping table being absent from the cache; communicating, to the memory device, a write command that indicates the portion of the address mapping table is to be stored in a set of latches of the memory device based at least in part on the address mapping table being associated with an access command that is part of a non-sequential read procedure and on reading the portion of the address mapping table; and updating a tracking table in the cache to indicate that the portion of the address mapping table is stored in the set of latches.
Aspect 2: The method, apparatus, or non-transitory computer-readable medium of aspect 1, where the non-sequential read procedure targets non-sequentially indexed logical addresses.
Aspect 3: The method, apparatus, or non-transitory computer-readable medium of any of aspects 1 through 2, further including operations, features, circuitry, logic, means, or instructions, or any combination thereof for refraining, after storing the portion of the address mapping table in the set of latches, from writing the portion of the address mapping table to the memory device based at least in part on determining that the portion of the address mapping table has not been changed.
Aspect 4: The method, apparatus, or non-transitory computer-readable medium of any of aspects 1 through 3, further including operations, features, circuitry, logic, means, or instructions, or any combination thereof for determining that an area of the cache reserved for address mapping information is full, where the portion of the address mapping table is stored in the set of latches based at least in part on the area being full.
Aspect 5: The method, apparatus, or non-transitory computer-readable medium of any of aspects 1 through 4, further including operations, features, circuitry, logic, means, or instructions, or any combination thereof for determining whether a range of logical addresses associated with a set of received access commands is less than a threshold range, where the portion of the address mapping table is read before receipt of the access command associated with the portion based at least in part on the range being less than the threshold range.
Aspect 6: The method, apparatus, or non-transitory computer-readable medium of any of aspects 1 through 5, further including operations, features, circuitry, logic, means, or instructions, or any combination thereof for receiving the access command associated with the portion of the address mapping table, where the portion of the address mapping table is read based at least in part on receipt of the access command.
Aspect 7: The method, apparatus, or non-transitory computer-readable medium of any of aspects 1 through 6, further including operations, features, circuitry, logic, means, or instructions, or any combination thereof for storing the portion of the address mapping table in the cache based at least in part on reading the portion of the address mapping table and determining to evict the portion of the address mapping table from the cache, where the portion of the address mapping table is stored in the set of latches based at least in part on determining to evict the portion of the address mapping table.
Aspect 8: The method, apparatus, or non-transitory computer-readable medium of any of aspects 1 through 7, further including operations, features, circuitry, logic, means, or instructions, or any combination thereof for determining that the portion of the address mapping table has an intermediate priority level, where the portion of the address mapping table is stored in the set of latches based at least in part on the portion of the address mapping table having the intermediate priority level.
Aspect 9: The method, apparatus, or non-transitory computer-readable medium of any of aspects 1 through 8, further including operations, features, circuitry, logic, means, or instructions, or any combination thereof for determining that a second access command associated with the portion of the address mapping table has been received and copying the portion of the address mapping table from the set of latches to the cache based at least in part on the access command.
Aspect 10: The method, apparatus, or non-transitory computer-readable medium of any of aspects 1 through 9, further including operations, features, circuitry, logic, means, or instructions, or any combination thereof for communicating, to the memory device, a first access command to access additional memory cells of the memory device, where the access command maintains the portion of the address mapping table in the set of latches of the memory device and communicating, to the memory device, a second access command to read the portion of the address mapping table from the set of latches based at least in part on executing an access command associated with the portion of the address mapping table.
Aspect 11: A method, apparatus, or non-transitory computer-readable medium including operations, features, circuitry, logic, means, or instructions, or any combination thereof for determining whether a portion of an address mapping table associated with an access command is absent from a cache of a controller, where the address mapping table including information for mapping logical addresses to physical addresses; determining, based at least in part on the portion of the address mapping table being absent from the cache, that the portion of the address mapping table is stored in a set of latches of a memory device; receiving the portion of the address mapping table from the set of latches of the memory device based at least in part on determining that the portion of the address mapping table is stored in the set of latches; and performing an access operation associated with the access command based at least in part on receiving the portion of the address mapping table.
Aspect 12: The method, apparatus, or non-transitory computer-readable medium of aspect 11, further including operations, features, circuitry, logic, means, or instructions, or any combination thereof for referencing a tracking table, in the cache, that indicates that the portion of the address mapping table is stored in set of latches, where the determination that the portion of the address mapping table is stored in the set of latches is based at least in part on referencing the tracking table.
Aspect 13: The method, apparatus, or non-transitory computer-readable medium of any of aspects 11 through 12, further including operations, features, circuitry, logic, means, or instructions, or any combination thereof for communicating, to the memory device, a read command for the portion that indicates the set of latches, where the portion of the address mapping table is received from the set of latches based at least in part on the read command.
Aspect 14: The method, apparatus, or non-transitory computer-readable medium of any of aspects 11 through 13, further including operations, features, circuitry, logic, means, or instructions, or any combination thereof for determining to evict a second portion of the address mapping table from the cache and storing the second portion of the address mapping table in a second set of latches based at least in part on determining to evict the second portion.
Aspect 15: The method, apparatus, or non-transitory computer-readable medium of aspect 14, further including operations, features, circuitry, logic, means, or instructions, or any combination thereof for determining that the second portion of the address mapping table has an intermediate priority level, where the second portion of the address mapping table is stored in the second set of latches based at least in part on the second portion of the address mapping table having the intermediate priority level.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:
Aspect 16: An apparatus, including: one or more memory devices; and one or more controllers coupled with the one or more memory devices and configured to cause the apparatus to: determine whether a portion of an address mapping table is absent from a cache of the controller, where the address mapping table includes information for mapping logical addresses to physical addresses; read the portion of the address mapping table from memory cells of the memory device based at least in part on the portion of the address mapping table being absent from the cache; communicate, to the memory device, a write command that indicates the portion of the address mapping table is to be stored in a set of latches of the memory device based at least in part on the address mapping table being associated with an access command that is part of a non-sequential read procedure and on reading the portion of the address mapping table; and update a tracking table in the cache to indicate that the portion of the address mapping table is stored in the set of latches.
Aspect 17: The apparatus of aspect 16, where the non-sequential read procedure targets non-sequentially indexed logical addresses.
Aspect 18: The apparatus of any of aspects 16 through 17, where the one or more controllers are further configured to cause the apparatus to: refrain, after storing the portion of the address mapping table in the set of latches, from writing the portion of the address mapping table to the memory device based at least in part on determining that the portion of the address mapping table has not been changed.
Aspect 19: The apparatus of any of aspects 16 through 18, where the one or more controllers are further configured to cause the apparatus to: determine that an area of the cache reserved for address mapping information is full, where the portion of the address mapping table is stored in the set of latches based at least in part on the area being full.
Aspect 20: The apparatus of any of aspects 16 through 19, where the one or more controllers are further configured to cause the apparatus to: determine whether a range of logical addresses associated with a set of received access commands is less than a threshold range, where the portion of the address mapping table is read before receipt of the access command associated with the portion based at least in part on the range being less than the threshold range.
Aspect 21: The apparatus of any of aspects 16 through 20, where the one or more controllers are further configured to cause the apparatus to: receive the access command associated with the portion of the address mapping table, where the portion of the address mapping table is read based at least in part on receipt of the access command.
Aspect 22: The apparatus of any of aspects 16 through 21, where the one or more controllers are further configured to cause the apparatus to: store the portion of the address mapping table in the cache based at least in part on reading the portion of the address mapping table; and determine to evict the portion of the address mapping table from the cache, where the portion of the address mapping table is stored in the set of latches based at least in part on determining to evict the portion of the address mapping table.
Aspect 23: The apparatus of any of aspects 16 through 22, where the controller is further configured to cause the apparatus to: determine that the portion of the address mapping table has an intermediate priority level, where the portion of the address mapping table is stored in the set of latches based at least in part on the portion of the address mapping table having the intermediate priority level.
Aspect 24: The apparatus of any of aspects 16 through 23, where the one or more controllers are further configured to cause the apparatus to: determine that a second access command associated with the portion of the address mapping table has been received; and copy the portion of the address mapping table from the set of latches to the cache based at least in part on the access command.
Aspect 25: The apparatus of any of aspects 16 through 24, where the one or more controllers are further configured to cause the apparatus to: communicate, to the memory device, a first access command to access additional memory cells of the memory device, where the access command maintains the portion of the address mapping table in the set of latches of the memory device; and communicate, to the memory device, a second access command to read the portion of the address mapping table from the set of latches based at least in part on executing an access command associated with the portion of the address mapping table.

An apparatus is described. The following provides an overview of aspects of the apparatus as described herein:
Aspect 26: An apparatus, including: one or more memory devices; and one or more controllers are coupled with the memory device and configured to cause the apparatus to: determine whether a portion of an address mapping table associated with an access command is absent from a cache of the controller, where the address mapping table including information for mapping logical addresses to physical addresses; determine, based at least in part on the portion of the address mapping table being absent from the cache, that the portion of the address mapping table is stored in a set of latches of the memory device; receive the portion of the address mapping table from the set of latches of the memory device based at least in part on determining that the portion of the address mapping table is stored in the set of latches; and perform an access operation associated with the access command based at least in part on receiving the portion of the address mapping table.
Aspect 27: The apparatus of aspect 26, where the one or more controllers are further configured to cause the apparatus to: reference a tracking table, in the cache, that indicates that the portion of the address mapping table is stored in set of latches, where the determination that the portion of the address mapping table is stored in the set of latches is based at least in part on referencing the tracking table.
Aspect 28: The apparatus of any of aspects 26 through 27, where the one or more controllers are further configured to cause the apparatus to: communicate, to the memory device, a read command for the portion that indicates the set of latches, where the portion of the address mapping table is received from the set of latches based at least in part on the read command.
Aspect 29: The apparatus of any of aspects 26 through 28, where the one or more controllers are further configured to cause the apparatus to: determine to evict a second portion of the address mapping table from the cache; and store the second portion of the address mapping table in a second set of latches based at least in part on determining to evict the second portion.
Aspect 30: The apparatus of aspect 29, where the one or more controllers are further configured to cause the apparatus to: determine that the second portion of the address mapping table has an intermediate priority level, where the second portion of the address mapping table is stored in the second set of latches based at least in part on the second portion of the address mapping table having the intermediate priority level.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory device; and
one or more controllers coupled with the memory device and configured to cause the apparatus to:
determine whether a portion of an address mapping table is absent from a cache of one or more controllers, wherein the address mapping table comprises information for mapping logical addresses to physical addresses;
read the portion of the address mapping table from memory cells of the memory device based at least in part on the portion of the address mapping table being absent from the cache;
communicate, to the memory device, a write command that indicates the portion of the address mapping table is to be stored in a set of latches of the memory device based at least in part on the address mapping table being associated with an access command that is part of a non-sequential read procedure and on reading the portion of the address mapping table; and
update a tracking table in the cache to indicate that the portion of the address mapping table is stored in the set of latches.

2. The apparatus of claim 1, wherein the non-sequential read procedure targets non-sequentially indexed logical addresses.

3. The apparatus of claim 1, wherein the one or more controllers are further configured to cause the apparatus to:
refrain, after storing the portion of the address mapping table in the set of latches, from writing the portion of the address mapping table to the memory device based at least in part on determining that the portion of the address mapping table has not been changed.

4. The apparatus of claim 1, wherein the one or more controllers are further configured to cause the apparatus to:
determine that an area of the cache reserved for address mapping information is full, wherein the portion of the address mapping table is stored in the set of latches based at least in part on the area being full.

5. The apparatus of claim 1, wherein the one or more controllers are further configured to cause the apparatus to:
determine whether a range of logical addresses associated with a set of received access commands is less than a threshold range, wherein the portion of the address mapping table is read before receipt of the access command associated with the portion based at least in part on the range being less than the threshold range.

6. The apparatus of claim 1, wherein the one or more controllers are further configured to cause the apparatus to:
receive the access command associated with the portion of the address mapping table, wherein the portion of the address mapping table is read based at least in part on receipt of the access command.

7. The apparatus of claim 1, wherein the one or more controllers are further configured to cause the apparatus to:
store the portion of the address mapping table in the cache based at least in part on reading the portion of the address mapping table; and
determine to evict the portion of the address mapping table from the cache, wherein the portion of the address mapping table is stored in the set of latches based at least in part on determining to evict the portion of the address mapping table.

8. The apparatus of claim 1, wherein the one or more controllers are further configured to cause the apparatus to:
determine that the portion of the address mapping table has an intermediate priority level, wherein the portion of the address mapping table is stored in the set of latches based at least in part on the portion of the address mapping table having the intermediate priority level.

9. The apparatus of claim 1, wherein the one or more controllers are further configured to cause the apparatus to:
determine that a second access command associated with the portion of the address mapping table has been received; and
copy the portion of the address mapping table from the set of latches to the cache based at least in part on the access command.

10. The apparatus of claim 1, wherein the one or more controllers are further configured to cause the apparatus to:
communicate, to the memory device, a first access command to access additional memory cells of the memory device, wherein the access command maintains the portion of the address mapping table in the set of latches of the memory device; and
communicate, to the memory device, a second access command to read the portion of the address mapping table from the set of latches based at least in part on executing an access command associated with the portion of the address mapping table.

11. An apparatus, comprising:
a memory device; and
one or more controllers coupled with the memory device and configured to cause the apparatus to:
determine whether a portion of an address mapping table associated with an access command is absent from a cache of the one or more controllers, wherein the address mapping table comprising information for mapping logical addresses to physical addresses;
determine, based at least in part on the portion of the address mapping table being absent from the cache, that the portion of the address mapping table is stored in a set of latches of the memory device;
receive the portion of the address mapping table from the set of latches of the memory device based at least in part on determining that the portion of the address mapping table is stored in the set of latches; and
perform an access operation associated with the access command based at least in part on receiving the portion of the address mapping table.

12. The apparatus of claim 11, wherein the one or more controllers are further configured to cause the apparatus to:
reference a tracking table, in the cache, that indicates that the portion of the address mapping table is stored in set of latches, wherein the determination that the portion of the address mapping table is stored in the set of latches is based at least in part on referencing the tracking table.

13. The apparatus of claim 11, wherein the one or more controllers are further configured to cause the apparatus to:
communicate, to the memory device, a read command for the portion that indicates the set of latches, wherein the portion of the address mapping table is received from the set of latches based at least in part on the read command.

14. The apparatus of claim 11, wherein the one or more controllers are further configured to cause the apparatus to:
determine to evict a second portion of the address mapping table from the cache; and
store the second portion of the address mapping table in a second set of latches based at least in part on determining to evict the second portion.

15. The apparatus of claim 14, wherein the one or more controllers are further configured to cause the apparatus to:
determine that the second portion of the address mapping table has an intermediate priority level, wherein the second portion of the address mapping table is stored in the second set of latches based at least in part on the second portion of the address mapping table having the intermediate priority level.

16. A method, comprising:
determining whether a portion of an address mapping table is absent from a cache of one or more controllers, wherein the address mapping table comprises information for mapping logical addresses to physical addresses;
reading the portion of the address mapping table from memory cells of a memory device based at least in part on the portion of the address mapping table being absent from the cache;
communicating, to the memory device, a write command that indicates the portion of the address mapping table is to be stored in a set of latches of the memory device based at least in part on the address mapping table being associated with an access command that is part of a non-sequential read procedure and on reading the portion of the address mapping table; and
updating a tracking table in the cache to indicate that the portion of the address mapping table is stored in the set of latches.

17. The method of claim 16, further comprising:
determining that an area of the cache reserved for address mapping information is full, wherein the portion of the address mapping table is stored in the set of latches based at least in part on the area being full.

18. The method of claim 16, further comprising:
determining whether a range of logical addresses associated with a set of received access commands is less than a threshold range, wherein the portion of the address mapping table is read before receipt of the access command associated with the portion based at least in part on the range being less than the threshold range.

19. The method of claim 16, further comprising:
storing the portion of the address mapping table in the cache based at least in part on reading the portion of the address mapping table; and
determining to evict the portion of the address mapping table from the cache, wherein the portion of the address mapping table is stored in the set of latches based at least in part on determining to evict the portion of the address mapping table.

20. The method of claim 16, further comprising:
determining that a second access command associated with the portion of the address mapping table has been received; and
copying the portion of the address mapping table from the set of latches to the cache based at least in part on the access command.
